(19) United States
(12) Patent Application Publication
(10) Pub. No.: US 2015/0323507 A1
(43) Pub. Date: Nov. 12, 2015

(54) METHOD AND SYSTEM OF IMPLEMENTING HIGH DIMENSIONAL HOLO-HILBERT SPECTRAL ANALYSIS

(71) Applicant: National Central University, Taoyuan City (TW)

(72) Inventor: Norden. E. HUANG, Jhongli City (TW)

(21) Appl. No.: 14/707,574

(22) Filed: May 8, 2015

Related U.S. Application Data
(60) Provisional application No. 61/990,828, filed on May 9, 2014.

(51) Int. Cl. G01N 29/46

(52) U.S. Cl. CPC G01N 29/46

(57) ABSTRACT

The present invention provides a method of implementing the high dimensional Holo-Hilbert spectral analysis which transforms a data from time domain to frequency domain. At the first of the steps, obtaining an amplitude intrinsic mode component and an instantaneous frequency component of the data by a mode decomposition, such as using Empirical Mode Decomposition (EMD), adaptive filtering, or optimal basis pursue, etc to show a plurality of amplitude intrinsic mode functions (amplitude IMFs) and a plurality of frequency intrinsic mode functions (frequency IMFs). Then, analyzing each of the amplitude IMFs and the frequency IMFs to obtain a plurality value in different high order components. At the last, to establish a high dimensional Holo-Hilbert spectrum by combining the high order component with the original component to show the interaction between frequency and amplitude. Consequently, the present invention not only discloses a spectrum that can represent all the possible processes: additive and multiplicative, intra- and inter-mode, stationary and nonstationary, linear and nonlinear interactions, but also makes a new index for quantifying the inter-mode degree of nonlinearity possible.

### FIELD OF THE INVENTION

The invention relates to a method and a system of implementing the high dimensional full-information Holo-Hilbert spectrum that including the frequency modulation and amplitude modulation variations of a nonlinear and nonstationary data.

### BACKGROUND OF THE INVENTION

In data analysis, tradition spectrum by definition is a transform of the temporal domain data into frequency domain. Consequently, the spectral analysis has become a powerful tool for exploring the statistical properties of the time series. Indeed, it has become the standard tool in studying all kinds of random vibration phenomena, such as earthquake, structure and machine vibrations, ocean waves, turbulence, speech, and even in biomedical research as in Electroencephalogram analysis and heart rate variability.

However, powerful as the Fourier spectral analysis is, there are severe limitations on its applicability. In fact, the limitations are true to all a priori basis approaches such as Fourier and Wavelet analyses, for they are all integral transforms: They all suffer from spurious harmonics, uncertainty principle restriction, and are meaningful only to stationary and linear data. Let us take Fourier expansion as an example; it is simply

$$x ( t ) = R {\sum }_{j = 0}^{N} {a}_{j} {e}^{i 2 π {f}_{j}}$$

Where the basis is e^{i2πft.}, in which R stands for the real part of the expansion, and both the amplitude, aⱼ, the frequency fⱼ are independent of time. Obviously, with the constant amplitude and frequency values, the Fourier based spectral analysis can only have full physical meaning for stationary processes. Actual data, natural or man-made, are not necessarily stationary. To accommodate the temporal variations, short time Fourier spectrogram and Wavelet analyses are introduced, which have added various measures on the temporal variations of the frequency in the from of a time-frequency presentations. Time-frequency sounds reasonable, but it is actually an incomplete spectral analysis, for it still contains temporal variable.

A more serious limitation of Fourier analysis is on its applications to data from nonlinear processes. With the introduction of Hilbert spectral analysis, we can resolve some of the limitations on nonlinearity when the expansion is based on an adaptive basis, the Intrinsic Mode Function (IMF) through Empirical Mode Decomposition (EMD),

$$x ( t ) = {\sum }_{j = 1}^{N} {c}_{j} ( t ) = {\sum }_{j = 1}^{N} {a}_{j} ( t ) cos {θ}_{j} ( t ) = R {\sum }_{j = 1}^{N} {a}_{j} ( t ) {e}^{i {\int }_{t} {ω}_{j} ( τ ) d τ}$$

Where the basis is aⱼ(t) cos(θⱼ(t)), and the frequency is defined as the time derivative of the adaptively determined phase function θⱼ(t); therefore, the transform is no longer through integration; consequently, the frequency is no longer a mean value over the time integration domain, but has instantaneous values defined through differentiation. Thus Hilbert spectral analysis has extended the time-frequency representation for non-stationary processes to a degree of accuracy unattainable with the integral transform methods. Furthermore, the instantaneous frequency could represent the intra-mode nonlinear distortion of the wave from without resort to the mathematical artifact of harmonics. Therefore, the intra-wave frequency variations in the Hilbert spectral analysis can yield a quantitative measure of degree of nonlinearity within each IMF mode and the whole data, designated as the intra-mode degree of nonlinearity.

Even with these generalizations, we have to face the fact that the time-frequency analyses represent an incomplete time to frequency transform. An even more fundamental flaw of all the existing spectral analysis methods is that they are all based on additive expansion; therefore, they still suffer one fatal and insurmountable difficulty: to represent any data resulting from multiplicative operations meaningfully. This flaw is deeply rooted to the fact that all mathematical expansions are additive expansions, which imply all processes have to be the results of additive operations. The genuine nonlinear processes, however, are the results of multiplicative operations. The effects of the multiplicative operation can be seen through the EMD expansion, for each IMF is consisted of the product of Amplitude and Frequency Modulation (AM and FM) terms.

Because of problems in tradition technology, the present invention provides a method and system of implementing high dimensional Holo-Hilbert Spectral Analysis (HHSA), which is a full information spectral analysis. By adding new dimensions in the spectral representation that will result in a hyper-dimensional spectrum. These new dimensions will enable us to represent not only the intra-mode nonlinear interactions, but also represent the complicated inter-mode modulations explicitly and quantitatively. This new full information Holo-Hilbert Spectrum (HHS) will fully represent both AM and FM variations.

### BRIEF DISCRIPTION OF THE INVENTION

The invention relates to a method and a system of implementing Holo-Hilbert spectral analysis. Specifically, a kind of data analysis to produce an amplitude modulation spectrum, a frequency modulation spectrum and an amplitude-frequency modulation spectrum.

The method of implementing Holo-Hilbert spectral analysis in amplitude modulation consists of the following steps: (A) after obtaining a data; (B) obtaining an initial amplitude intrinsic mode component of the data by a mode decomposition method, such as the method by using empirical mode decomposition (EMD), adaptive filtering, or optimal basis pursue, etc comprises a plurality of amplitude intrinsic mode functions; then (C) to every the amplitude intrinsic mode function, obtaining the absolute value of the target amplitude intrinsic mode function, and producing an amplitude envelope line going through all the maxima of the absolute value; (D) using the mode decomposition method for analyzing the target amplitude intrinsic mode function to obtain an first order amplitude intrinsic mode components, the first order amplitude intrinsic mode components comprise a plurality of first order amplitude intrinsic mode functions; (E) repeating step (C) to step (D) for all the initial amplitude intrinsic functions, until obtaining the first order amplitude intrinsic mode components and the plurality of all first order amplitude intrinsic mode functions from all of the amplitude intrinsic mode functions; furthermore, (F) combining the initial amplitude intrinsic mode component and the plurality of first order amplitude intrinsic mode components to obtain an amplitude modulation spectrum, wherein in the amplitude modulation spectrum, the plurality of first order amplitude intrinsic mode functions are corresponding to the plurality of amplitude intrinsic mode functions in a same time axis.

On the other hand, the system of implementing Holo-Hilbert spectral analysis in amplitude modulation, comprises: a data received unit, obtaining a data; a data spectrum combined unit connect with the data received unit through an amplitude modulation unit, performing all the above stated steps.

The method of implementing Holo-Hilbert spectral analysis in frequency modulation consists of the following steps: (A) after obtaining a data; (B) obtaining an initial instantaneous frequency component of the data by a mode decomposition method, comprises a plurality of frequency intrinsic mode functions; then (C) to every frequency intrinsic mode function, then obtaining an absolute value of the target frequency intrinsic mode function, and producing a frequency envelope line which going through all the maxima of the absolute value; (D) using the mode decomposition method for analyzing the frequency envelope line to obtain an first order instantaneous frequency component, the first order instantaneous frequency component comprises a plurality of first order frequency intrinsic mode functions; (E) repeating step (C) to step (D) to all initial instantaneous frequency functions, until obtaining the first order instantaneous frequency component and the plurality of first order frequency intrinsic mode functions from all of frequency intrinsic mode functions; furthermore, combining the initial instantaneous frequency component and the plurality of first order instantaneous frequency components to obtain a frequency modulation spectrum, wherein in the frequency modulation spectrum, the plurality of first order frequency intrinsic mode functions are corresponding to the plurality of frequency intrinsic mode functions in a same time axis.

On the other hand, the system of implementing Holo-Hilbert spectral analysis in frequency modulation, comprises: a data received unit, obtaining a data; a data spectrum combined unit connects with the data received unit through a frequency modulation unit, performing all the above stated steps.

The method of implementing Holo-Hilbert spectral analysis in a mix of amplitude modulation and frequency modulation consists of the following steps: (A) after obtaining a data; (B) obtaining an initial amplitude intrinsic mode component and an initial instantaneous frequency component of the data by a mode decomposition method, wherein the initial amplitude intrinsic mode component comprises a plurality of amplitude intrinsic mode functions, and the initial instantaneous frequency component comprises a plurality of frequency intrinsic mode functions.

Then (C1) to every initial amplitude in sic mode function, then obtaining an absolute value of the target amplitude intrinsic mode function, and producing an amplitude envelope line which identifies all the maxima of the amplitude intensity absolute value; (D1) using the mode decomposition method for analyzing the amplitude envelope line to obtain an first order amplitude intrinsic mode component, the first order amplitude intrinsic mode component comprises a plurality of first order amplitude intrinsic mode functions; (E1) choosing another one of the amplitude intrinsic mode functions, to repeat step (C1) to step (D1), until obtaining the first order amplitude intrinsic mode component and the plurality of first order amplitude intrinsic mode functions from all of the amplitude intrinsic anode functions; (F1) combining the initial amplitude intrinsic mode component and the plurality of first order amplitude intrinsic mode components to obtain a amplitude modulation spectrum, wherein in the amplitude modulation spectrum, the plurality of first order amplitude intrinsic mode functions are corresponding to the plurality of amplitude intrinsic mode functions in a same time axis;

Then (C2) to every initial frequency intrinsic mode function, then obtaining a frequency absolute value of the target frequency intrinsic mode function, and producing a frequency envelope line which identifies all the maxima of the frequency intensity absolute value; (D2) using the mode decomposition method for analyzing the frequency envelope line to obtain an first order instantaneous frequency component, the first order instantaneous frequency component comprises a plurality of first order frequency intrinsic mode functions, (E2) choosing another one of the first order frequency intrinsic mode functions, repeat step (C2) to step (D2), until obtaining the first order instantaneous frequency component and the plurality of first order frequency intrinsic mode functions from all of frequency intrinsic mode functions; (F2) combining the initial instantaneous frequency component and the plurality of first order instantaneous frequency components to obtain a frequency modulation spectrum, wherein in the frequency modulation spectrum, the plurality of first order frequency intrinsic mode functions are corresponding to the plurality of frequency intrinsic mode functions in a same time axis;

Furthermore, combining the amplitude modulation spectrum and the frequency modulation spectrum to obtain an amplitude-frequency modulation spectrum, wherein in the amplitude-frequency modulation spectrum, the plurality of first order amplitude intrinsic mode functions are corresponding to the plurality of first order frequency intrinsic mode functions in the same time axis.

On the other hand, the system of implementing Holo-Hilbert spectral analysis in a mix of amplitude modulation and frequency modulation, comprises:

A data received unit, obtaining a data.

An amplitude modulation unit connects with the data received unit, obtaining an initial amplitude intrinsic mode component of the data by a mode decomposition method, and performing the above operations as [0013].

A frequency modulation unit connect with the data received unit, obtaining an instantaneous frequency function of the data by a mode decomposition method, and performing the above operations as [0014]

And a data spectrum combined unit connect with the amplitude modulation unit, combining the initial amplitude intrinsic mode component and all the plurality of first order amplitude intrinsic mode components to obtain a amplitude modulation spectrum, wherein in the amplitude modulation spectrum, the plurality of first order amplitude intrinsic mode functions are corresponding to the plurality of amplitude intrinsic mode functions in a same time axis, and combining the initial instantaneous frequency component and all the plurality of first order instantaneous frequency components to obtain a frequency modulation spectrum, wherein in the frequency modulation spectrum, the plurality of first order frequency intrinsic mode functions are corresponding to the plurality of frequency intrinsic mode functions in a same time axis, furthermore, combining the amplitude modulation spectrum and the frequency modulation spectrum to obtain an amplitude-frequency modulation spectrum, wherein in the amplitude-frequency modulation spectrum, the plurality of first order amplitude intrinsic mode functions are corresponding to the plurality of the first order frequency intrinsic mode functions in the same time axis.

In the following description, it is clear to understand by studying detail embodiments of the present invention. Please refer FIG. 1 to FIG. 19.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram showing the Holo-Hilbert spectral analysis system;

FIG. 2 is a schematic flow showing the method of implementing Holo-Hilbert spectral analysis in amplitude modulation;

FIG. 3 is a schematic diagram showing an initial amplitude intrinsic mode component;

FIG. 4 is a schematic diagram showing an amplitude envelope line through all of a absolute value;

FIG. 5 is a schematic diagram showing an first order amplitude intrinsic mode component comprises a plurality of first order amplitude intrinsic mode functions;

FIG. 6 is a schematic flow showing the method of implementing Holo-Hilbert spectral analysis in frequency modulation;

FIG. 7 is a schematic flow showing the method of implementing Holo-Hilbert spectral analysis in a mix of amplitude modulation and frequency modulation;

FIG. 8 is a schematic diagram showing the length of day dates during 1960 to 2014;

FIG. 9 is a schematic diagram showing an initial amplitude intrinsic mode component from FIG. 8;

FIG. 10 is a schematic diagram showing the Hilbert spectral of FIG. 9

FIG. 11 is a schematic diagram showing an amplitude envelope line of an amplitude intrinsic mode function (half-month) from FIG. 9;

FIG. 12 is a schematic diagram showing an first order amplitude intrinsic mode component from FIG. 11;

FIG. 13 is a schematic diagram showing an amplitude modulation spectrum (the first order) of FIG. 8, which combines the initial amplitude intrinsic mode component from FIG. 9 and the plurality of first order amplitude intrinsic mode components from FIG. 12;

FIG. 14 is a schematic diagram showing a second order amplitude intrinsic mode component from FIG. 12

FIG. 15 is a schematic diagram showing a frequency modulation spectrum (the first order) of FIG. 8, which combines the initial instantaneous frequency component and all the plurality of first order instantaneous frequency components;

FIG. 16 is a schematic diagram showing a relation graph between a frequency variety value of every half-month and a frequency intrinsic mode function of the frequency variety value from FIG. 15;

FIG. 17 is a schematic diagram showing an amplitude-frequency modulation spectrum of FIG. 8, which combines the initial amplitude intrinsic mode component and the initial instantaneous frequency component;

FIG. 18A is a schematic diagram showing a beat-to-beat data from a young health subject;

FIG. 18B is a schematic diagram showing a beat-to-beat data from a congestive heart failure (CHF) subject;

FIG. 19 A is a schematic diagram showing a modulation spectrum of the beat-to-beat data from a young health subject; and

FIG. 19 B is a schematic diagram showing a modulation spectrum of the beat-to-beat data from a congestive heart failure (CHF) subject.

### DETAILED DESCRIPTION OF THE EMBODIMENTS

The present invention discloses a method of implementing high dimensional Holo-Hilbert spectral analysis to show the variations of data in the frequency modulation (FM) and amplitude modulation (AM). It can not only be used by the independent system, but also can be used by analysis equipment which connects to computer or microprocessor through web. Therefore, an embodiment of the present invention can be designed as a program saves into any kind of media.

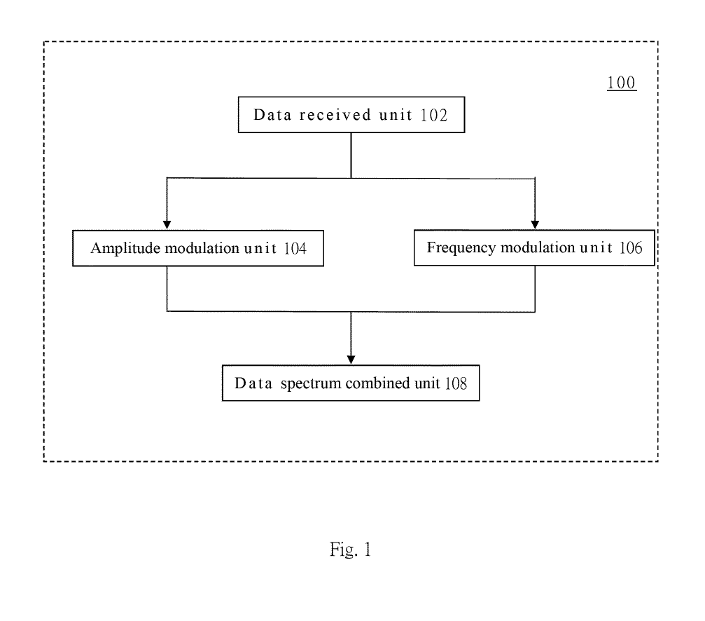

Please refer FIG. 1, FIG. 1 is a schematic diagram showing the high dimensional Holo-Hilbert spectral analysis system. The analysis system 100 compires a data received unit 102, an amplitude modulation unit 104, a frequency modulation unit 106 and a data spectrum combined unit 108, wherein the amplitude modulation unit 104 and the frequency modulation unit 106 connect with the data received unit 102, the data spectrum combined unit 106 connect with the amplitude modulation unit 104 and the frequency modulation unit 106.

Because the different in the method of implementing modulation, each unit coupled is not limited. Specifically, producing an amplitude modulation spectrum, a frequency modulation spectrum and an amplitude-frequency modulation spectrum.

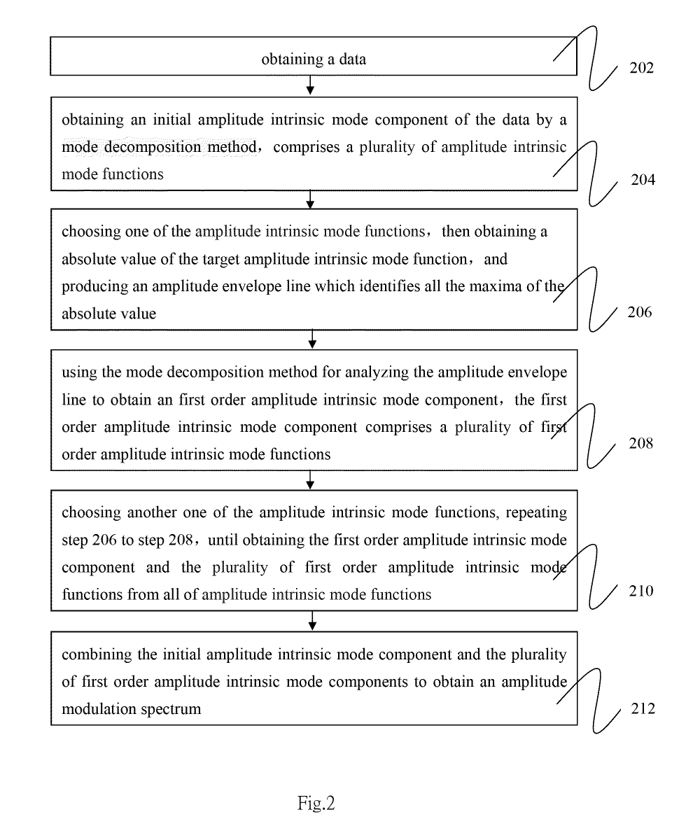

Please refer FIG. 2, FIG. 2 is a schematic flow showing the method of implementing Holo-Hilbert spectral analysis in amplitude modulation. First of all, at step 202, after the data received unit 102 obtains a data, The data will be analyzed by the amplitude modulation unit 104, at step 204, obtaining an initial amplitude intrinsic mode component of the data by a mode decomposition method, such as the method by using empirical mode decomposition (EMD), adaptive filtering, or optimal basis pursue, comprises a plurality of amplitude intrinsic mode functions; then, at step 206, choosing one of the amplitude intrinsic mode functions, obtaining an absolute value of the target amplitude intrinsic mode function, and producing an amplitude envelope line which identifies all the maxima intrinsic of the absolute value; at step 208, using the mode decomposition method for analyzing the amplitude envelope line to obtain a first order amplitude intrinsic mode component, the first order amplitude intrinsic mode component comprises a plurality of first order amplitude intrinsic mode functions; at step 210, repeating step 206 to 208 to choose another one of the amplitude intrinsic mode functions, until obtaining the first order amplitude intrinsic mode component and the plurality of first order amplitude intrinsic mode functions from all of the amplitude intrinsic mode functions.

In an embodiment, above method can choose other one of the first order amplitude intrinsic mode functions, repeating step 202 to step 208, until obtaining a second order amplitude intrinsic mode component and a plurality of second order amplitude intrinsic mode functions from all of the first order amplitude intrinsic mode functions; Furthermore, repeating above steps, until obtaining a n-th order amplitude intrinsic mode components and a plurality of n-th order amplitude intrinsic mode functions from all of the (n−1)-th order amplitude intrinsic mode functions, and the plurality of n order amplitude intrinsic mode functions have no cyclic characteristics.

Finally, at step 212, the data spectrum combined unit 106 combines the initial amplitude intrinsic mode component and the plurality of all the first order amplitude intrinsic mode components to obtain an amplitude modulation spectrum, wherein in the amplitude modulation spectrum, the plurality of first order amplitude intrinsic mode functions are corresponding to the plurality of amplitude intrinsic mode functions in a same time axis.

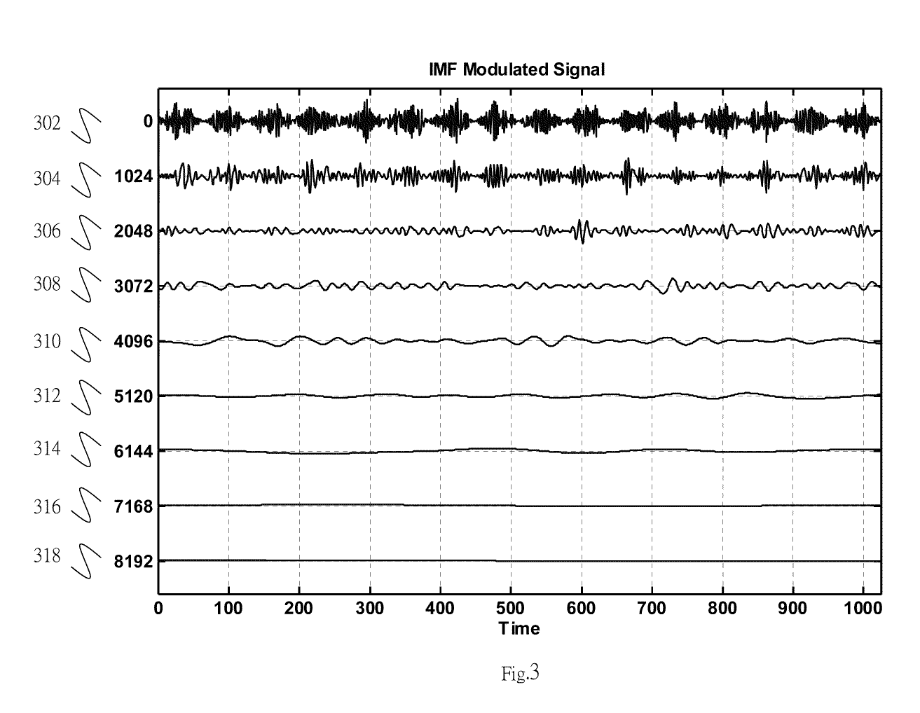

In an embodiment, please refer FIG. 3, FIG. 3 is a schematic diagram showing an initial amplitude intrinsic mode component. The amplitude modulation unit 104 at step 204, using EMD method for analyzing the data to obtaining the initial amplitude intrinsic mode component 300 of the data, includes a plurality of amplitude intrinsic mode function 302, 304, 306, 308310, 312, 314, 318, etc, wherein the plurality of amplitude intrinsic mode functions are the amplitude value changes over time of the data in each different frequency scale. The initial amplitude intrinsic mode component 300 also shows a frequency distribution of the data.

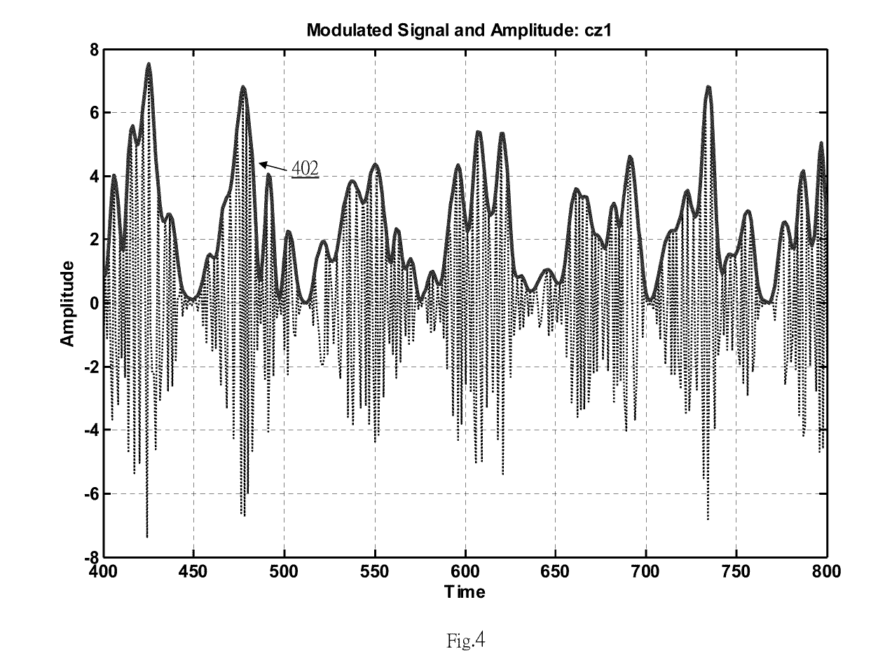

In another embodiment, please refer FIG. 4, FIG. 4 is a schematic diagram showing an amplitude envelope line through all of the absolute value, the amplitude modulation unit 104 at step 206, choosing a amplitude intrinsic mode function 302 from the initial amplitude intrinsic mode component 300, then obtaining a absolute value of the target amplitude intrinsic mode function 302, producing an amplitude envelope line 402 which identifies all the maxima of the absolute value by natural spline.

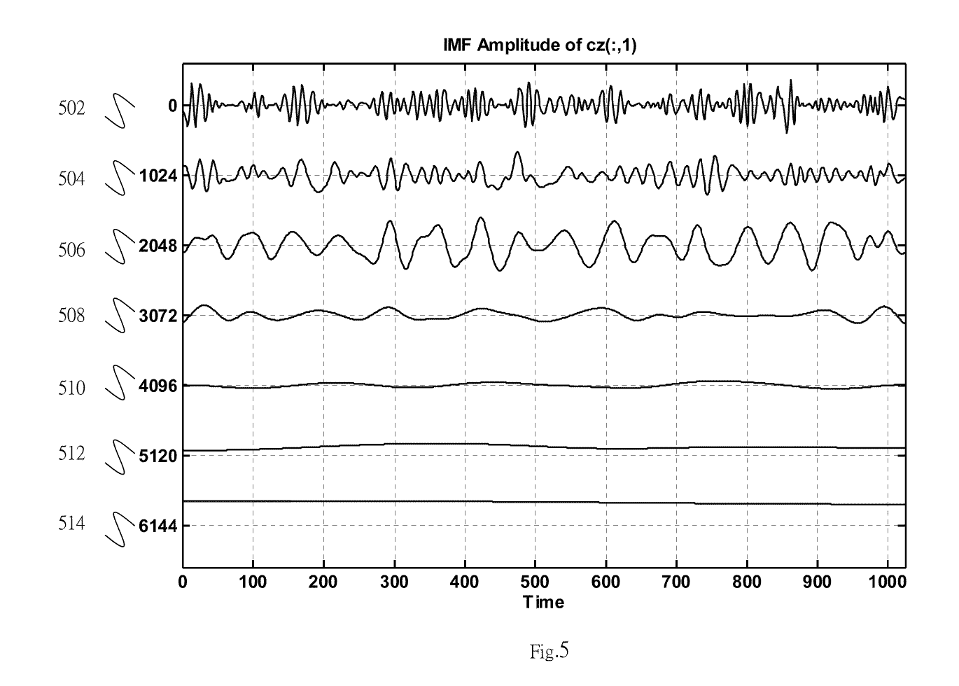

In another embodiment, please refer FIG. 5, FIG. 5 is a schematic diagram showing a first order amplitude intrinsic mode component comprises a plurality of first order amplitude intrinsic mode functions. The amplitude modulation unit 104 at step 208, using EMD method for analyzing the amplitude envelope line 402 of FIG. 4 to obtain a first order amplitude intrinsic mode component 500, the first order amplitude intrinsic mode component 500 comprises a plurality of first order amplitude intrinsic mode functions, 502, 504, 506, 508, 510, 514, etc. The first order amplitude intrinsic mode functions are the value changes over time of the envelope line 402 in each different first order frequency scale.

The procedures outlined above should be iterated to delineate the additive or multiplicative clearly in the data by adding new dimensions as given in the schematic flow chart. Indeed, the modulation could be embedded in the data in many orders. The combined spectrum to produce a single higher dimensional representation is given as follows:

$$x ( t ) = R {\sum }_{j = 1}^{N} {a}_{j} ( t ) {e}^{i {\int }_{t} {Ω}_{i} ( x ) d x} \to \to \to \to H ( ω , t ) \\ ⇓ \\ R {\sum }_{k = 1}^{{L}_{j}} {a}_{jk} ( t ) {e}^{i {\int }_{t} {Ω}_{b} ( x ) d x} \\ ⇓ \\ R {\sum }_{l = 1}^{{L}_{j}} {a}_{jkl} ( t ) {e}^{i {\int }_{t} {Ω}_{i} ( x ) d x} \\ ⇓ \\ …$$

Therefore, to the first order, we essentially have

$${a}_{j} ( t ) = {\sum }_{k} [ R {\sum }_{l} {a}_{jkl} ( t ) {e}^{i {\int }_{t} {Ω}_{i} ( τ ) d τ} ] {e}^{i {\int }_{t} {Ω}_{k} ( τ ) d τ}$$

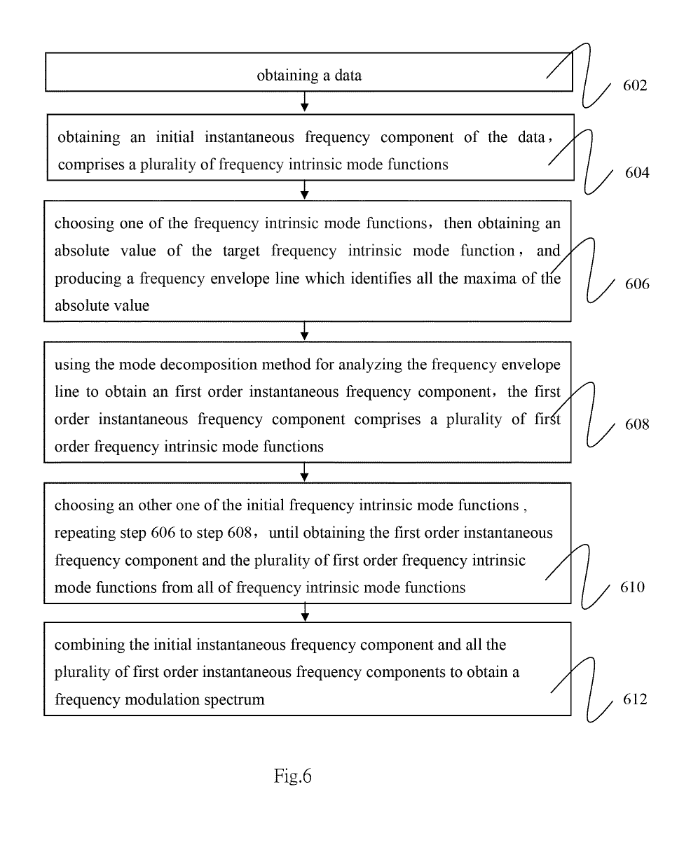

Please refer FIG. 6, FIG. 6 is a schematic flow showing the method of implementing Holo-Hilbert spectral analysis in frequency modulation. First of all, at step 602, after the data received unit 102 obtains a data, The data will be analyzed by the frequency modulation unit 106, at step 604, obtaining an initial instantaneous frequency component of the data by a mode decomposition method, comprises a plurality of frequency intrinsic mode functions; then, at step 606, choosing one of the frequency intrinsic mode functions, obtaining an absolute value of the target frequency intrinsic mode function, and producing a frequency envelope line which identifies all the maxima of the absolute value; at step 608, using the mode decomposition method for analyzing the frequency envelope line to obtain a first order instantaneous frequency component, the first order instantaneous frequency component comprises a plurality of first order frequency intrinsic mode functions; at step 610, repeating step 606 to 608 to choose another one of the frequency intrinsic mode functions, until obtaining the first order instantaneous frequency component and the plurality of first order frequency intrinsic mode functions from all of frequency intrinsic mode functions.

In an embodiment, above method can choose other one of the first order frequency intrinsic mode functions, repeating step 602 to step 608, until obtaining a second order instantaneous frequency component and a plurality of second order frequency intrinsic mode functions from all of first order frequency intrinsic mode functions; Furthermore, repeating above steps, until obtaining a n-th order instantaneous frequency component and a plurality of n-th order frequency intrinsic mode functions from all of the (n−1)-th order frequency intrinsic mode functions, until the plurality of n-th order frequency intrinsic mode functions have no cyclic characteristics.

Finally, at step 612, the data spectrum combined unit 106 combines the initial instantaneous frequency component and the plurality of first order instantaneous frequency component to obtain a frequency modulation spectrum, wherein in the frequency modulation spectrum, the plurality of first order frequency intrinsic mode functions are corresponding to the plurality of frequency intrinsic mode functions in a same time axis.

By analogy, we should also have the frequency modulation (FM) as

$${ω}_{j} ( t ) = {\sum }_{k = 1}^{{L}_{i}} {b}_{jk} ( t ) {e}^{i {\int }_{t} {v}_{k} ( x ) d x} ⇒ {p}_{j} ( v , t ) \\ ⇓ \\ {\sum }_{l = 1}^{{L}_{j}} {b}_{jkl} ( t ) {e}^{i {\int }_{t} {v}_{l} ( x ) d x} \\ ⇓ \\ …$$

$$Or$$

$${ω}_{j} ( t ) = {\sum }_{k} [ R {\sum }_{l} {b}_{jkl} ( t ) {e}^{i {\int }_{t} {φ}_{l} ( τ ) d τ} ] {e}^{i {\int }_{t} {φ}_{k} ( τ ) d τ}$$

A special significance can also be assigned to the variation of the FM modulations, which could be extremely useful in revealing the Amplitude-phase interactions. This variation can be constructed easily combining the Hilbert energy spectrum, H(ω,t) with pⱼ(v,t) to get

$$H ( ω , t ) ⇒ t = t ( ω )$$

$${p}_{j} ( v , t ) = {p}_{j} ( v , t ( ω ) ) = {P}_{j} ( v , ω )$$

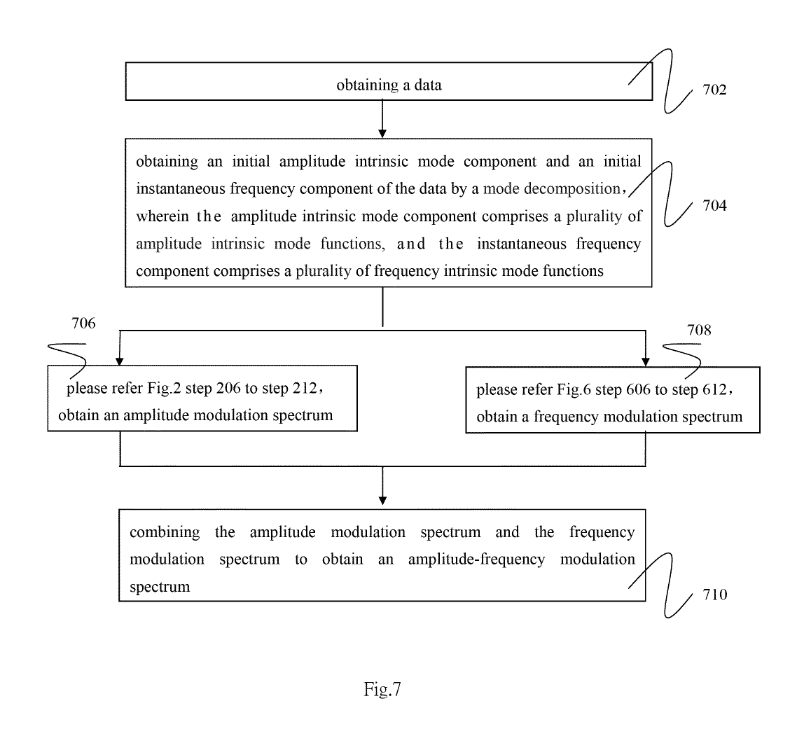

Please refer FIG. 7, FIG. 7 is a schematic flow showing the method of implementing Holo-Hilbert spectral analysis in a mix of amplitude modulation and frequency modulation. First of all, at step 702, after the data received unit 102 obtains a data, the data will be analyzed by the amplitude modulation unit 104 and the frequency modulation unit 106, At step 704, by a mode decomposition method, obtaining an initial amplitude intrinsic mode component of the data, comprises a plurality of amplitude intrinsic mode functions, and obtaining an initial instantaneous frequency component of the data, comprises a plurality of frequency intrinsic mode functions; Then, at step 706, refer step 206 to 212 of FIG. 2, obtaining the amplitude modulation spectrum; Similarly, at step 708, refer step 706 to 712 of FIG. 7, obtaining the frequency modulation spectrum; Furthermore, at step 710, combining the amplitude modulation spectrum and the frequency modulation spectrum to obtain a amplitude-frequency modulation spectrum, wherein in the amplitude-frequency modulation spectrum, the plurality of the first order amplitude intrinsic mode functions are corresponding to the plurality of first order frequency intrinsic mode functions in the same time axis.

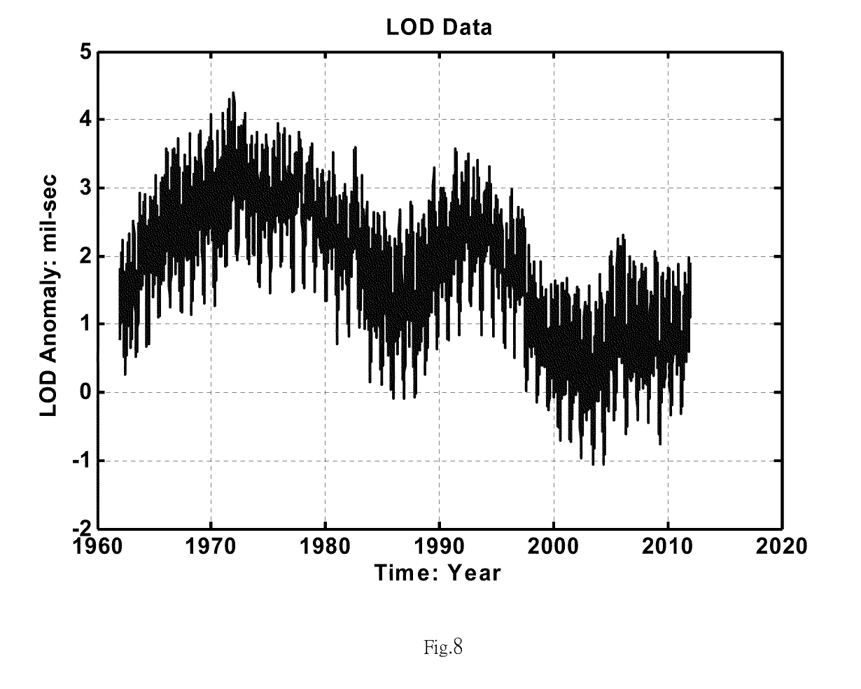

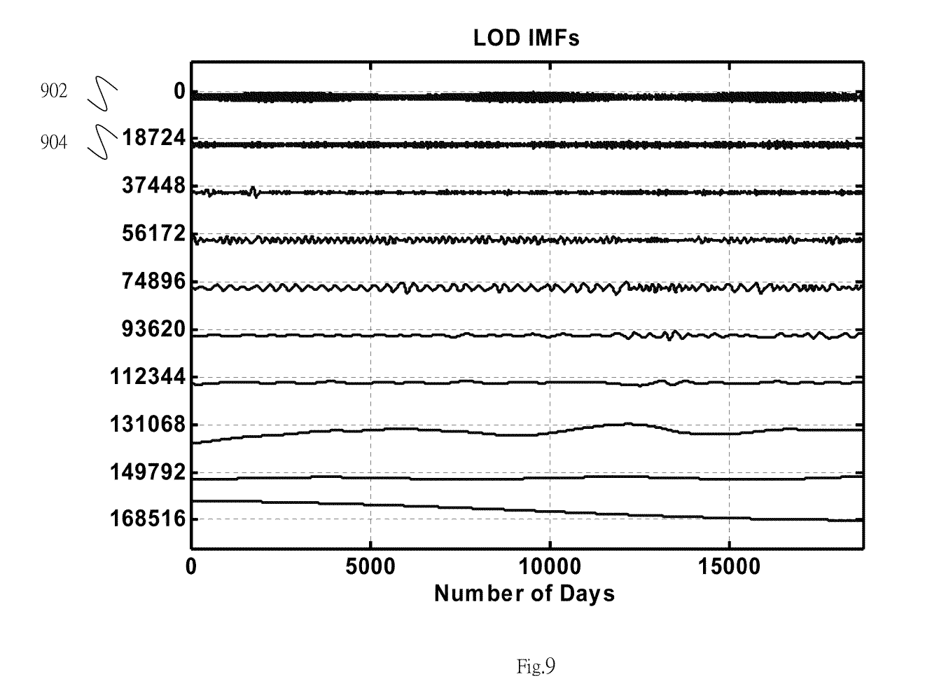

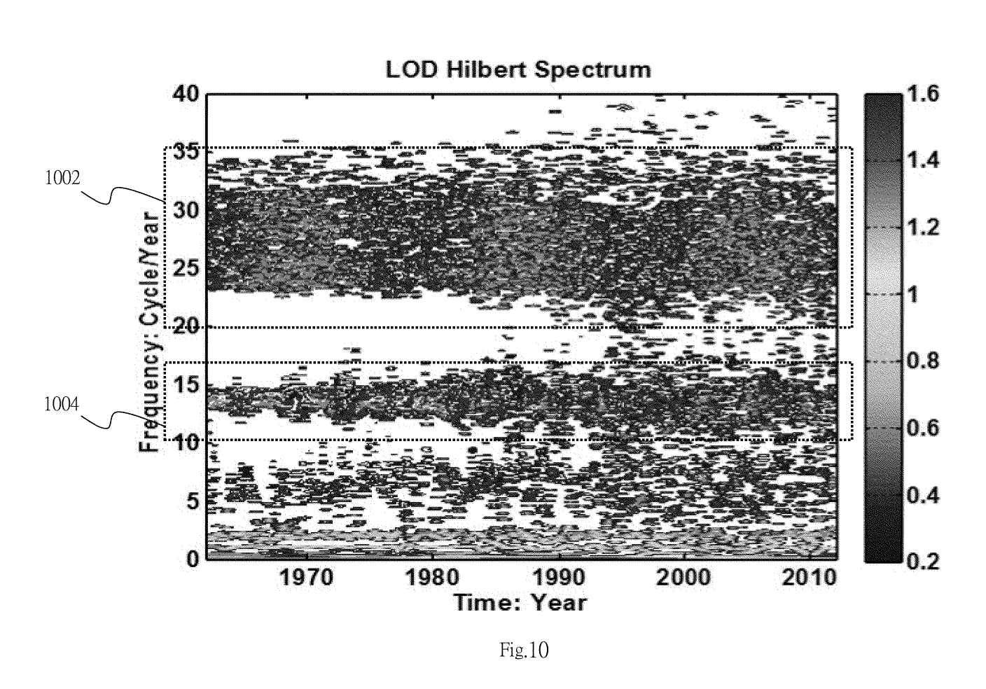

In an embodiment, please refer FIG. 8 to FIG. 14. FIG. 8 is a schematic diagram showing the length of day dates during 1960 to 2014, the time length of one day (mil-sec) is the amplitude of data, and the value of data shows the time length changes over the past few years. FIG. 9 is a schematic diagram showing an initial amplitude intrinsic mode component from FIG. 8, obtaining an initial amplitude intrinsic mode component of the data by EMD method, comprises a plurality of amplitude intrinsic mode functions, wherein the plurality of amplitude intrinsic mode functions are the amplitude value changes over time of the data in each different frequency scale, includes a plurality of amplitude intrinsic mode functions, a half-monthly cycles 902, a monthly cycles 904, etc. FIG. 10 is a schematic diagram showing the Hilbert spectral of FIG. 9, the most prominent features of the IMFs is the 19 years Metonic cycle amplitude modulation in the component representing the half-monthly tide residing in the frequency band of 24 to near 30 cycles per year (region 1002), which is not in any of the IMFs, nor in the marginal Hilbert spectrum. It should be noted that the large amplitude in the second (region 1004) to the last IMF is not the Metonic cycle, for it is has the wrong phase, periodicity and magnitude. For the monthly tide, we can see a 4 yearly cycle.

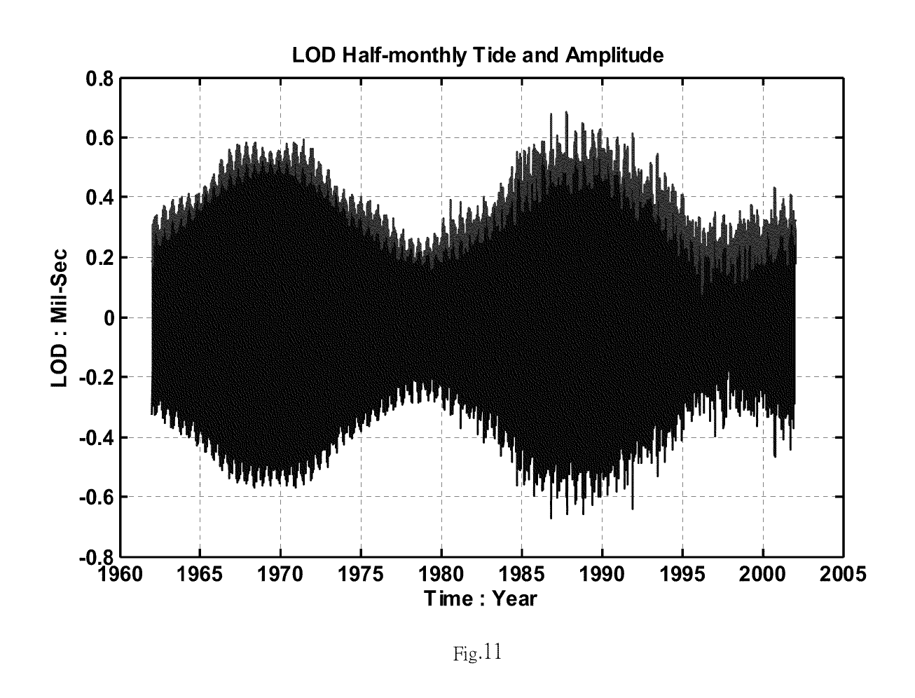

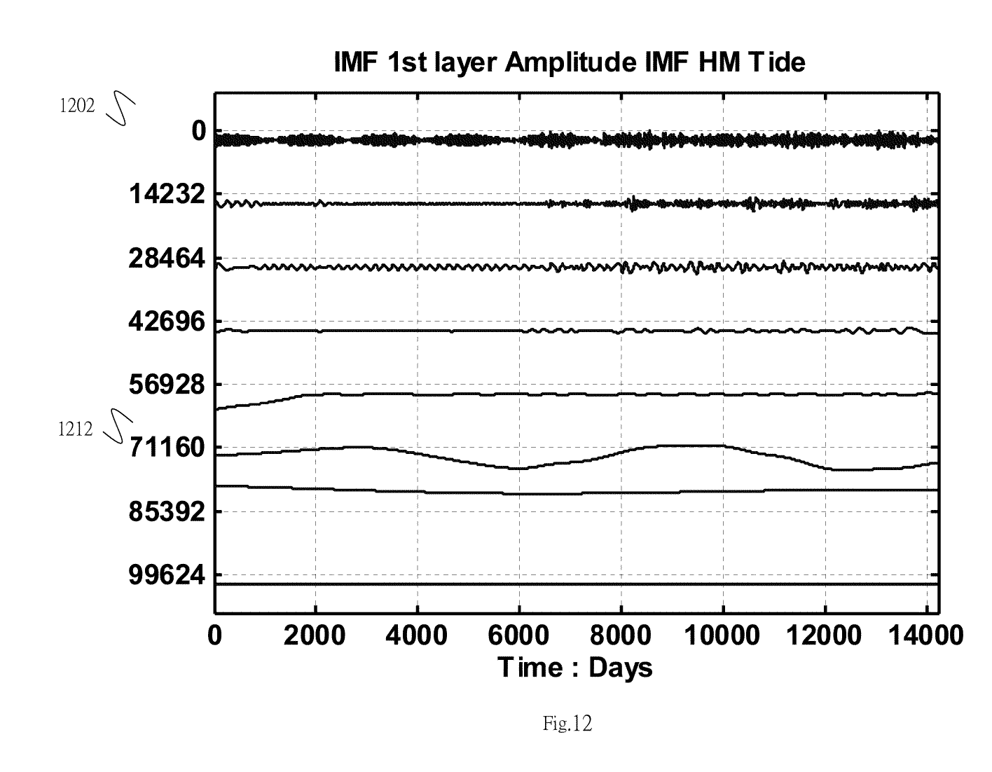

However no amount of filtering and decomposition could we extract these features from the data or in spectral representation. It could be clearly seen if we examine the amplitude modulation through constructing the envelope of the half-monthly cycles 902, obtaining a first order amplitude intrinsic mode component. FIG. 11 is a schematic diagram showing an amplitude envelope line of an amplitude intrinsic mode function (half-month) from FIG. 9, using empirical mode decomposition (EMD) method to show the value changes over time of the amplitude envelope line 1102 in each different first order frequency scale. FIG. 12 is a schematic diagram showing an amplitude modulation spectrum from FIG. 11; now, in this set of first order amplitude intrinsic mode functions, we can see the Metonic cycle clearly in sixth first order dimension amplitude intrinsic mode functions 1212, and gives a roughly 4 year amplitude modulation cycle for the first order amplitude intrinsic mode functions 1202.

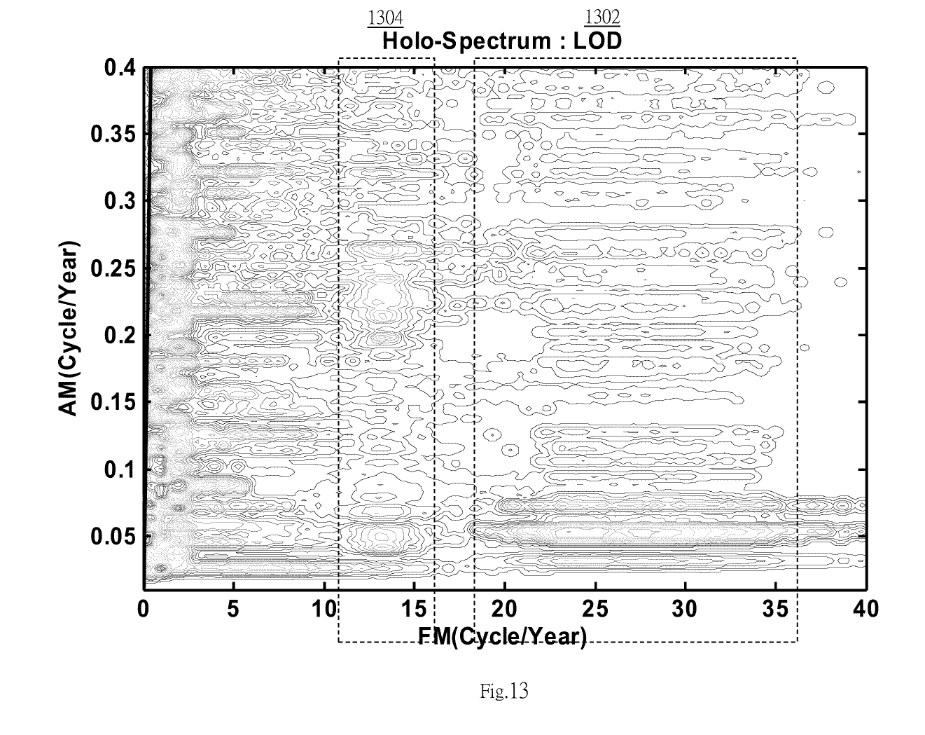

Furthermore, FIG. 13 is a schematic diagram showing an amplitude modulation spectrum (first order) of FIG. 8, which combines the initial amplitude intrinsic mode component from FIG. 9 and the plurality of first order amplitude intrinsic mode components from FIG. 12; We can see the modulation patterns for all the different time scales including the Metonic cycle (near 0.5 cycles/year) for both monthly 1302 and half-monthly 1304 tidal bands and the Olympiad cycle is also clearly seen for the monthly tide 1302. Therefore, it is unnecessary to decompose the additional axis of amplitude modulation by a specific frequency vector, the data can be decomposed by any kind of frequency vector.

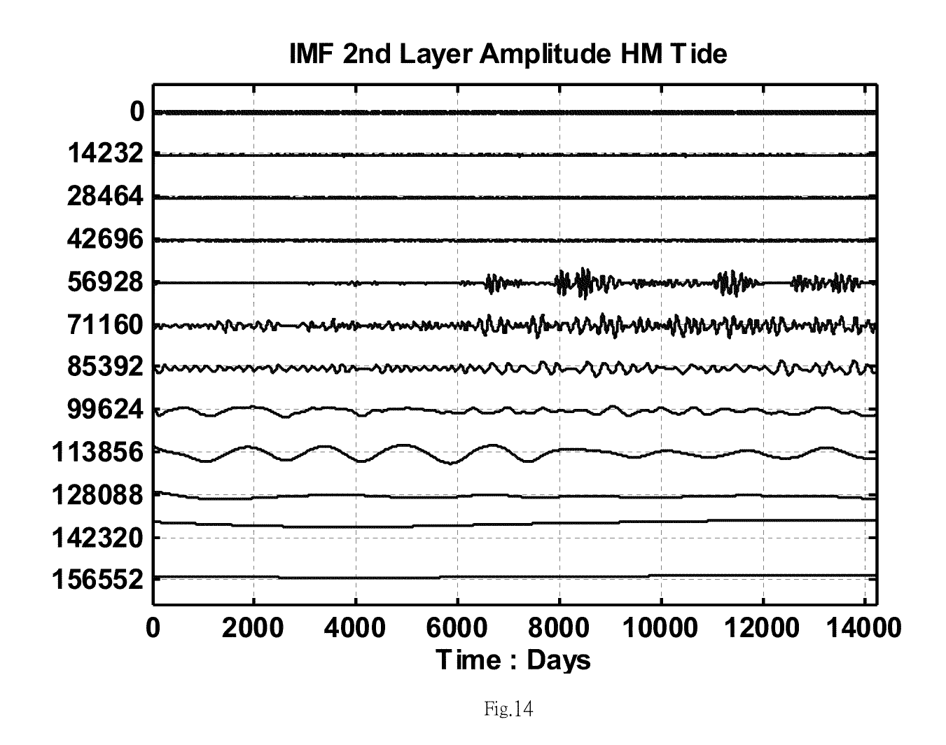

Then we can repeat to choose a (n−1)-th order amplitude intrinsic mode functions, obtaining a n-th order amplitude intrinsic mode component and a plurality of n-th order amplitude intrinsic mode functions from all of the (n−1)-th order amplitude intrinsic mode functions, until the plurality of n order amplitude intrinsic mode functions have no cyclic characteristics. FIG. 14 is a schematic diagram showing a second order amplitude intrinsic mode component from FIG. 12, choosing the first order amplitude intrinsic mode function 1202, and using empirical mode decomposition method for analyzing an amplitude envelope line from the first order amplitude intrinsic mode function 1202 to obtain two amplitude intrinsic mode component and a plurality of second order amplitude intrinsic mode functions. Wherein the second order amplitude intrinsic mode component also reveals a strong wave pattern of the 4-year Olympiad cycle.

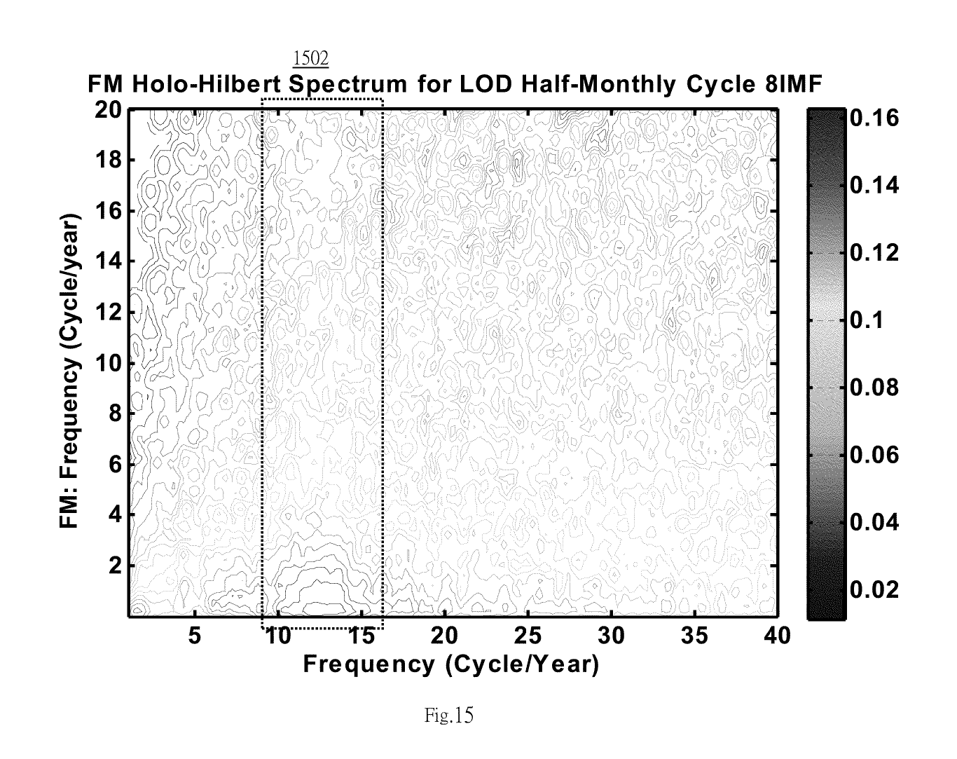

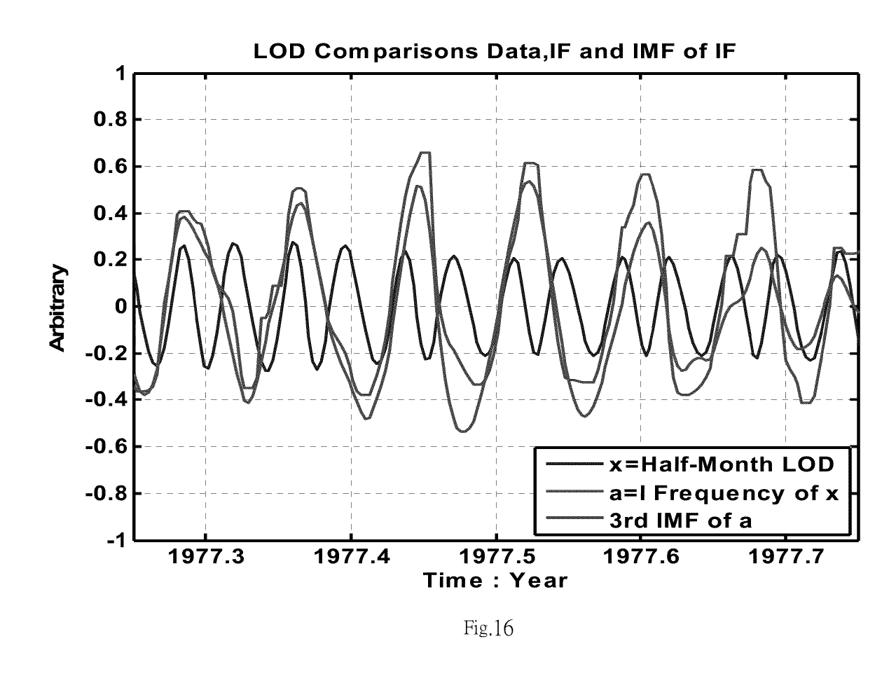

In an embodiment, please refer FIGS. 15 to 16, FIG. 15 s a schematic diagram showing a frequency modulation spectrum (the first order) of FIG. 8, which combines the initial instantaneous frequency component and the plurality of first order instantaneous frequency components, wherein band 1502 to show the coincide period of different calendars. FIG. 16 is a schematic diagram showing a relation graph between a frequency variety value of every half-month and a frequency intrinsic mode function of the frequency variety value from FIG. 15, may quantify a nonlinearity index of data by comparing each of the IMFs. Clearly, we can see that the intra-wave instantaneous frequency modulation is over the period of monthly cycle, analogous to a sub-harmonic modulation. The presentation in FIG. 15 is somewhat indirect, for it did not relate the half-monthly frequency directly with the monthly frequency.

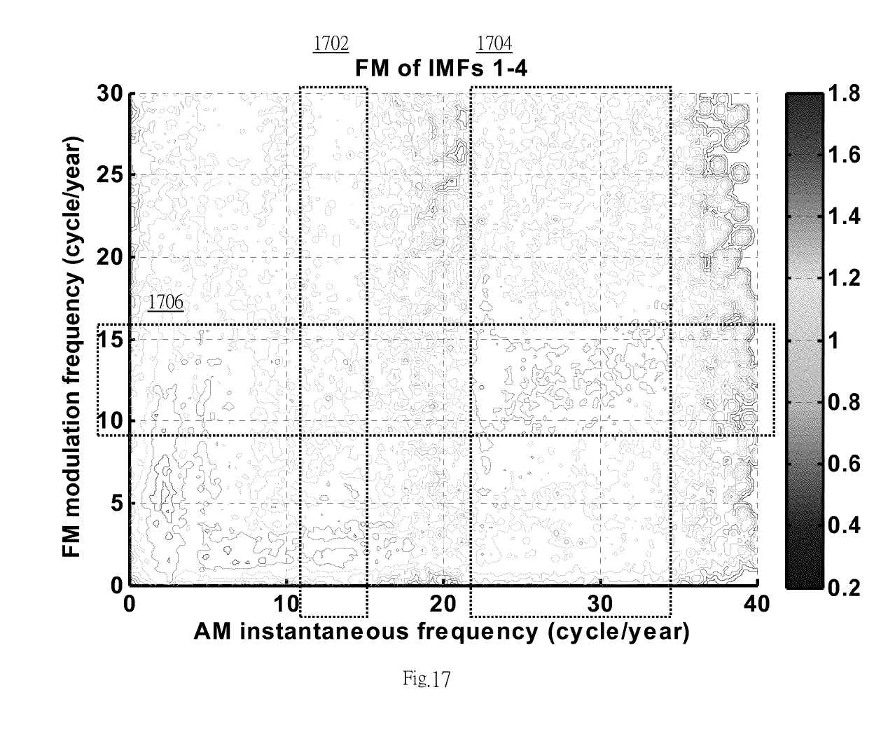

In an embodiment, please refer FIG. 17, FIG. 17 is a schematic diagram showing an amplitude-frequency modulation spectrum of FIG. 8, which combines the initial amplitude intrinsic mode component and the initial instantaneous frequency component. In FIG. 17, the bands 1702 and 1704 are correspond to the spectrum of FIG. 10 which shows the bands 1002 and 1004, the bands 1706 is correspond to the spectrum of FIG. 15 which shows the band 1502. Wherein the half-monthly cycles of amplitude intrinsic mode component 1702 is affected by the monthly cycles of instantaneous frequency component 1704.

The method and system of implementing Holo-Hilbert spectral analysis not only can solve the problems of physics, but also can be use to assess biomedical data, such as a no-liner signal of electroencephalogram EEG).

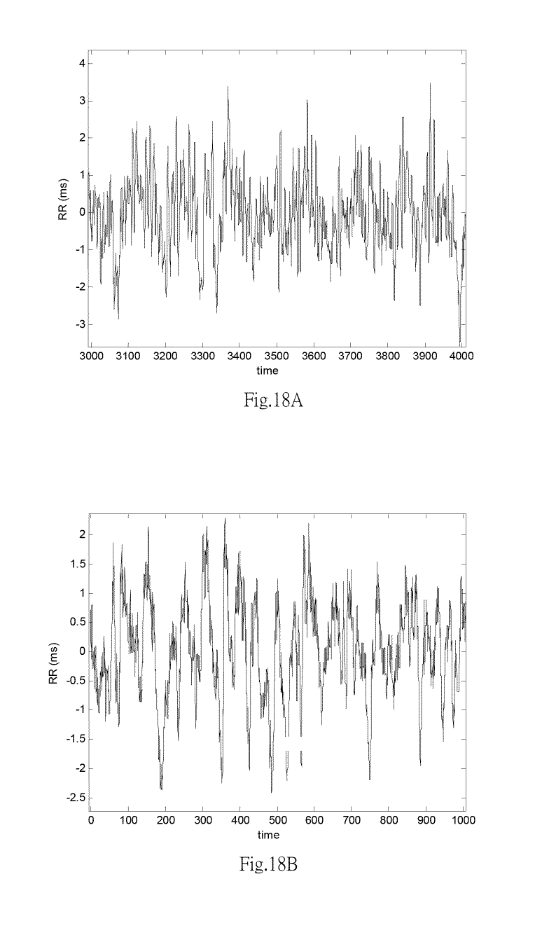

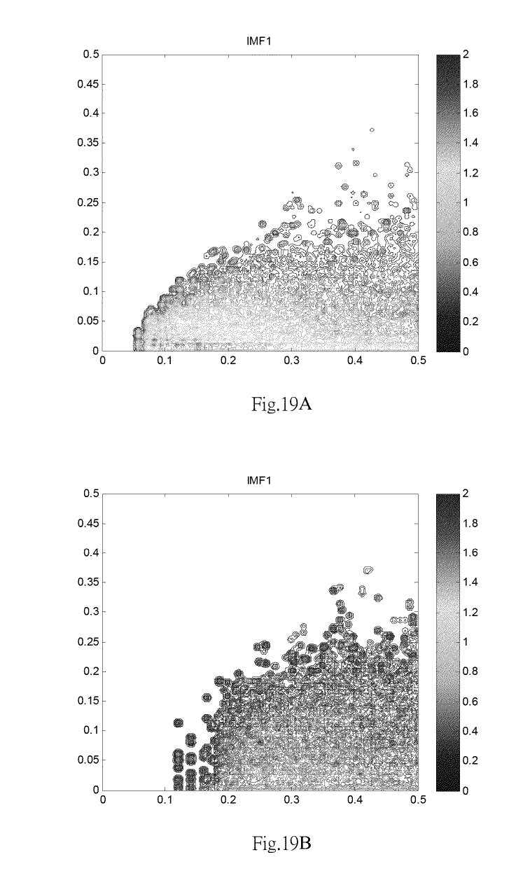

In an embodiment, please refer FIGS. 18 and 19, FIG. 18 A is a schematic diagram showing a beat-to-beat data from a young health subject, FIG. 18 B is a schematic diagram showing a beat-to-beat data from a congestive heart failure (CHF) subject. In the present invention, we can obtain an amplitude-frequency modulation spectrum from the beat-to-beat data, FIG. 19 A is a schematic diagram showing a modulation spectrum of the beat-to-beat data from a young health subject, FIG. 19 B is a schematic diagram showing a modulation spectrum of the beat-to-beat data from a congestive heart failure (CHF) subject, it is clear to show the heartbeat decline of a elderly subject and CHF subject. Doctors can identify pathological conditions of the subject by implementing Holo-Hilbert spectral analysis, such as assessing the difference of the beat-to-beat data from the CHF subject.

From the above discussions, we can see that the high dimensional Holo-Hilbert spectral actually can represent the multiplicative interactions; it enables us to examine the details of all the nonlinear interactions through intra-mode or inter-mode frequency fluctuations. The inter-mode interactions are actually the results of the all-important inter-scale couplings or simply coupled system, which have all been left out in the past spectral analysis. The capabilities of different spectral analysis methods could be summarized in the following table, F stands for frequency, and TF, for time-frequency representation.

| | Decomposition | | | Nonlinearity | |
|---|---|---|---|---|---|
| | | Multipli- | Nonsta- | Intra- | Inter- |
| Methods | Additive | cation | tionary | mode | mode |
| Fourier | Yes | No | No | May be?* | No |
| Hilbert: TF | Yes | No | Yes | Yes | No |
| Hilbert: F | Yes | No | No | Yes | No |
| HHSA: TF | Yes | Yes | Yes | Yes | Yes |
| HHSA: F | Yes | Yes | No | Yes | Yes |

As discussed above, the linearity should be expressed in terms of the additive decomposition components, while the nonlinearity should be expressed in terms of the amplitude modulation. In the EMD expansion of the amplitude, if we take the sum without the last trend term, if any, as

$$y ( t ) = {\sum }_{j = 1}^{N - 1} {\sum }_{k = 1}^{{L}_{l} - 1} {a}_{jk} ( t ) cos {θ}_{j} ( t )$$

Then, every term is zero-mean and orthogonal to each other. Consequently, the total energy of amplitude modulation should be

$$\overline{{y}^{2} ( t )} = \frac{1}{2} {\sum }_{j = 1}^{N - 1} {\sum }_{k = 1}^{{L}_{l} - 1} \overline{{a}_{jk}^{2} ( t )}$$

As a result, we can define the degree of inter-mode nonlinearity the depth of the modulation as

$${N}_{in} = \frac{{\sum }_{j = 1}^{N - 1} \overline{{[ {a}_{j} ( t ) - \overline{{a}_{j} ( t )} ]}^{2}}}{{\sum }_{j = 1}^{N} \vec{{a}_{j}^{2} ( t )}} = \frac{std ( {a}_{j} ( t ) )}{rms ( {a}_{j} ( t ) )}$$

Based on this definition, the maximum nonlinearity should be unity, when the trend term for amplitude function is identically zero, then the total energy of the amplitude is identical to the signal. This is total modulation; the Degree of nonlinearity should be unity, the highest value possible. All other cases, the value should be less. The other extreme is for all the amplitude to be constant and the modulation is zero, or a linear case. Thus we should have a degree of inter-mode nonlinearity between 0 and 1 just as in the case of intra-wave case.

What is claimed includes:

1. A method of implementing Holo-Hilbert spectral analysis in amplitude modulation, the steps comprise:
(A) obtaining a data;
(B) obtaining an initial amplitude intrinsic mode component of the data by a mode decomposition method, comprises a plurality of amplitude intrinsic mode functions, wherein the plurality of amplitude intrinsic mode functions are the amplitude value changes over time of the data in each different frequency scale;
(C) choosing one of the amplitude intrinsic mode functions, then obtaining a absolute value of the target amplitude intrinsic mode function, and producing an amplitude envelope line which identifies all the maxima of the absolute value;
(D) using the mode decomposition method for analyzing the amplitude envelope line to obtain a first order amplitude intrinsic mode component, the first order amplitude intrinsic mode component comprises a plurality of first order amplitude intrinsic mode functions, wherein the first order amplitude intrinsic mode functions are the value changes over time of the amplitude envelope line in each different first order frequency scale;
(E) choosing another one of the amplitude intrinsic mode functions, repeating step (C) to step (D), until obtaining the first order amplitude intrinsic mode component and the plurality of first order amplitude intrinsic mode functions from all of the amplitude intrinsic mode functions; and
(F) combining the initial amplitude intrinsic mode component and all the plurality of first order amplitude intrinsic mode components to obtain an amplitude modulation spectrum, wherein in the amplitude modulation spectrum, the plurality of first order amplitude intrinsic mode functions are corresponding to the plurality of amplitude intrinsic mode functions in a same time axis.

2. The method according to claim 1, wherein the mode decomposition method is empirical mode decomposition method.

3. The method according to claim 1, the steps further include:
(E1) choosing another one of the first order amplitude intrinsic mode functions, repeating step (C) to step (E), until obtaining a second order amplitude intrinsic mode component and a plurality of second order amplitude intrinsic mode functions from all of the first order amplitude intrinsic mode functions; and
(E2) repeating step (C) to step (E1), until obtaining a n-th order amplitude intrinsic mode component and a plurality of n-th order amplitude intrinsic mode functions from all of the (n−1)-th order amplitude intrinsic mode functions, and the plurality of n-th order amplitude intrinsic mode functions have no cyclic characteristics.

4. A system of implementing Holo-Hilbert spectral analysis in amplitude modulation, comprises:
a data received unit, obtaining a data;
an amplitude modulation unit connect with the data received unit, obtaining an initial amplitude intrinsic mode component of the data by a mode decomposition method, comprises a plurality of amplitude intrinsic mode functions, wherein the plurality of amplitude intrinsic mode functions are the amplitude value changes over time of the data in each different frequency scale, choosing one of the amplitude intrinsic mode functions, then obtaining an absolute value of the target amplitude intrinsic mode function, and producing an amplitude envelope line which identifies all the maxima of the absolute value, using the mode decomposition method for analyzing the amplitude envelope line to obtain an first order amplitude intrinsic mode component, the first order amplitude intrinsic mode component comprises a plurality of first order amplitude intrinsic mode functions, wherein the first order amplitude intrinsic mode functions are the value changes over time of the amplitude envelope line in each different first order frequency scale, repeating to choose another one of the amplitude intrinsic mode functions, until obtaining the first order amplitude intrinsic mode component and the plurality of first order amplitude intrinsic mode functions from all of the amplitude intrinsic mode functions; and
a data spectrum combined unit connect with the amplitude modulation unit, combining the initial amplitude intrinsic mode component and all the plurality of first order amplitude intrinsic mode components to obtain a amplitude modulation spectrum, wherein in the amplitude modulation spectrum, the plurality of first order amplitude intrinsic mode functions are corresponding to the plurality of amplitude intrinsic mode functions in a same time axis.

5. The system according to claim 4, wherein the mode decomposition method is empirical mode decomposition method.

6. The system according to claim 4, wherein the amplitude modulation unit further includes:
repeating to choose one of the first order amplitude intrinsic mode functions, until obtaining a second order amplitude intrinsic mode component and a plurality of second order amplitude intrinsic mode functions from all of the first order amplitude intrinsic mode functions, furthermore, repeating to choose one of a plurality of (n-1)-th order amplitude intrinsic mode functions to obtain a n-th order amplitude intrinsic mode component and a plurality of n order amplitude intrinsic mode functions, until the plurality of n-th order amplitude intrinsic mode functions have no cyclic characteristics.

7. A method of implementing Holo-Hilbert spectral analysis in frequency modulation, the steps comprise:
(A) obtaining a data;
(B) obtaining an initial instantaneous frequency component of the data by a mode decomposition method, comprises a plurality of frequency intrinsic mode functions, wherein the plurality of frequency intrinsic mode functions are the variable frequency value changes over time of the data in each different frequency scale;
(C) choosing one of the frequency intrinsic mode functions, then obtaining an absolute value of the target frequency intrinsic mode function, and producing a frequency envelope line which identifies all the maxima of the absolute value;
(D) using the mode decomposition method for analyzing the frequency envelope line to obtain an first order instantaneous frequency component, the first order instantaneous frequency component comprises a plurality of first order frequency intrinsic mode functions, wherein the first order frequency intrinsic mode functions are the value changes over time of the frequency envelope line in each different first order frequency scale;
(E) choosing another one of the frequency intrinsic mode functions, repeating step (C) to step (D), until obtaining the first order instantaneous frequency component and the plurality of first order frequency intrinsic mode functions from all of frequency intrinsic mode functions; and
(F) combining the initial instantaneous frequency component and the plurality of first order instantaneous frequency component to obtain a frequency modulation spectrum, wherein in the frequency modulation spectrum, the plurality of first order frequency intrinsic mode functions are corresponding to the plurality of frequency intrinsic mode functions in a same time axis.

8. The method according to claim 7, wherein the mode decomposition method is empirical mode decomposition method.

9. The method according to claim 7, the steps further include:
(E1) choosing another one of the first order frequency intrinsic mode functions, repeating step (C) to step (E), until obtaining a second order instantaneous frequency component and a plurality of second order frequency intrinsic mode functions; and
(E2) repeating step (C) to step (E1), until obtaining a n-th order instantaneous frequency component and a plurality of n-th order frequency intrinsic mode functions from all of the (n−1)-th order frequency intrinsic mode functions, and the plurality of n-th order frequency intrinsic mode functions have no cyclic characteristics.

10. A system of implementing Holo-Hilbert spectral analysis in frequency modulation, comprises:
a data received unit, obtaining a data;
a frequency modulation unit connect with the data received unit, obtaining an initial instantaneous frequency component by a mode decomposition method, comprises a plurality of frequency intrinsic mode functions, wherein the plurality of frequency intrinsic mode functions are the variable frequency value changes over time of the data in each different frequency scale, choosing one of the frequency intrinsic mode functions, then obtaining an absolute value of the target frequency intrinsic mode function, and producing a frequency envelope line which identifies all the maxima of the absolute value, using the mode decomposition method for analyzing the frequency envelope line to obtain an first order instantaneous frequency component, the first order instantaneous frequency component comprises a plurality of first order frequency intrinsic mode functions, wherein the first order frequency intrinsic mode functions are the value changes over time of the frequency envelope line in each different first order frequency scale, repeating to choose another one of the frequency intrinsic mode functions, until obtaining the first order instantaneous frequency component and the plurality of first order frequency intrinsic mode functions from all of the frequency intrinsic mode functions; and
a data spectrum combined unit connect with the frequency modulation unit, combining the initial instantaneous frequency component and all the plurality of first order instantaneous frequency components to obtain a frequency modulation spectrum, wherein in the frequency modulation spectrum, the plurality of first order frequency intrinsic mode functions are corresponding to the plurality of frequency intrinsic mode functions in a same time axis.

11. The system according to claim 10, wherein the mode decomposition method is empirical mode decomposition method.

12. The system according to claim 10, wherein the frequency modulation unit further includes:
repeating to choose one of the first order frequency intrinsic mode functions, until obtaining a second order instantaneous frequency component and a plurality of second order frequency intrinsic mode functions from all of the first order frequency intrinsic mode functions, furthermore, repeating to choose one of a plurality of (n−1)-th order frequency intrinsic mode functions to obtain a n order instantaneous frequency component and a plurality of n-th order frequency intrinsic mode functions, until the plurality of n-th order frequency intrinsic mode functions have no cyclic characteristics.

13. A method of implementing Holo-Hilbert spectral analysis in a mix of amplitude modulation and frequency modulation, the steps comprise:
(A) obtaining a data;
(B) obtaining an initial amplitude intrinsic mode component and an initial instantaneous frequency component of the data by a mode decomposition method, wherein the initial amplitude intrinsic mode component comprises a plurality of amplitude intrinsic mode functions, shows the amplitude value changes over time of the data in each different frequency scale, and the initial instantaneous frequency component comprises a plurality of frequency intrinsic mode functions, shows the variable frequency value changes over time of the data in each different frequency scale;
(C1) choosing one of the amplitude intrinsic mode functions, then obtaining a absolute value of the target amplitude intrinsic mode function, and producing an amplitude envelope line which identifies all the maxima of the absolute value;
(D1) using the mode decomposition method for analyzing the amplitude envelope line to obtain an first order amplitude intrinsic mode component, the first order amplitude intrinsic mode component comprises a plurality of first order amplitude intrinsic mode functions, wherein the first order amplitude intrinsic mode functions are the value changes over time of the amplitude envelope line in each different first order frequency scale;
(E1) choosing another one of the amplitude intrinsic mode functions, repeating step (C1) to step (D1), until obtaining the other first order amplitude intrinsic mode component and the plurality of first order amplitude intrinsic mode functions from all of the amplitude intrinsic mode functions;
(F1) combining the initial amplitude intrinsic mode component and all the plurality of first order amplitude intrinsic mode components to obtain an amplitude modulation spectrum, wherein in the amplitude modulation spectrum, the plurality of first order amplitude intrinsic mode functions are corresponding to the plurality of amplitude intrinsic mode functions in a same time axis;
(C2) choosing one of the frequency intrinsic mode functions, then obtaining an absolute value of the target frequency intrinsic mode function, and producing a frequency envelope line which identifies all the maxima of the absolute value;
(D2) using the mode decomposition method for analyzing the frequency envelope line to obtain an first order instantaneous frequency component, the first order instantaneous frequency component comprises a plurality of first order frequency intrinsic mode functions, wherein the first order frequency intrinsic mode functions are the value changes over time of the frequency envelope line in each different first order frequency scale;
(E2) choosing another one of frequency intrinsic mode functions, repeating step (C2) to step (D2), until obtaining the fist order instantaneous frequency component and the plurality of first order frequency intrinsic mode functions from all of frequency intrinsic mode functions;
(F2) combining the initial instantaneous frequency component and all the plurality of first order instantaneous frequency components to obtain a frequency modulation spectrum, wherein in the frequency modulation spectrum, the plurality of first order frequency intrinsic mode functions are corresponding to the plurality of frequency intrinsic mode functions in the same time axis; and
(G) combining the amplitude modulation spectrum and the frequency modulation spectrum to obtain an amplitude-frequency modulation spectrum, wherein in the amplitude-frequency modulation spectrum, the plurality of first order amplitude intrinsic mode functions are corresponding to the plurality of first order frequency intrinsic mode functions in the same time axis.

14. The method according to claim 13, wherein the mode decomposition method is empirical mode decomposition method.

15. The method according to claim 13, the steps further include:
(E1a) choosing another one of the first order amplitude intrinsic mode functions, repeating step (C1) to step (E1), until obtaining a second order amplitude intrinsic mode component and a plurality of second order amplitude intrinsic mode functions; and
(E1b) repeating step (C1) to step (E1a), until obtaining a n-th order amplitude intrinsic mode components and a plurality of n-th order amplitude intrinsic mode functions from all of the (n−1)-th order amplitude intrinsic mode functions, and the plurality of n order amplitude intrinsic mode functions have no cyclic characteristics.

16. The method according to claim 17, the steps further include:
(E2a) choosing another one of the first order frequency intrinsic mode functions, repeating step (A) to step (E2), until obtaining a second order instantaneous frequency component and a plurality of second order frequency intrinsic mode functions; and
(E2b) repeating step (A) to step (E2a), until obtaining a n-th order instantaneous frequency component and a plurality of n-th order frequency intrinsic mode functions from all of the (n−1)-th order frequency intrinsic mode functions, and the plurality of n-th order frequency intrinsic mode functions have no cyclic characteristics.

17. A system of implementing Holo-Hilbert spectral analysis in a mix of amplitude modulation and frequency modulation, comprises:
a data received unit, obtaining a data;
an amplitude modulation unit connect with the data received unit, obtaining an initial amplitude intrinsic mode component of the data by a mode decomposition method, comprises a plurality of amplitude intrinsic mode functions, wherein the plurality of amplitude intrinsic mode functions are the amplitude value changes over time of the data in each different frequency scale, choosing one of the amplitude intrinsic mode functions, then obtaining an absolute value of the target amplitude intrinsic mode function, and producing an amplitude envelope line which identifies all the maxima of the absolute value, using the mode decomposition method for analyzing the amplitude envelope line to obtain a first order amplitude intrinsic mode component, the first order amplitude intrinsic mode component comprises a plurality of first order amplitude intrinsic mode functions, wherein the first order amplitude intrinsic mode functions are the value changes over time of the amplitude envelope line in each different first order frequency scale, repeating to choose another one of the amplitude intrinsic mode functions, until obtaining the first order amplitude intrinsic mode component and the plurality of first order amplitude intrinsic mode functions from all of the amplitude intrinsic mode functions;
a frequency modulation unit connect with the data received unit, obtaining an initial instantaneous frequency component by the mode decomposition method, comprises a plurality of frequency intrinsic mode functions, wherein the plurality of frequency intrinsic mode functions are the variable frequency value changes over time of the data in each different frequency scale, choosing one of the frequency intrinsic mode functions, then obtaining an absolute value of the target frequency intrinsic mode function, and producing a frequency envelope line which identifies all the maxima of the absolute value, using the mode decomposition method for analyzing the frequency envelope line to obtain an first order instantaneous frequency component, the first order instantaneous frequency component comprises a plurality of first order frequency intrinsic mode functions, wherein the first order frequency intrinsic mode functions are the value changes over time of the frequency envelope line in each different first order frequency scale, repeating to choose another one of the frequency intrinsic mode functions, until obtaining the first order instantaneous frequency component and the plurality of first order frequency intrinsic mode functions from all of the frequency intrinsic mode functions; and
a data spectrum combined unit connect with the amplitude modulation unit, combining the initial amplitude intrinsic mode component and all the plurality of first order amplitude intrinsic mode components to obtain an amplitude modulation spectrum, wherein in the amplitude modulation spectrum, the plurality of first order amplitude intrinsic mode functions are corresponding to the plurality of amplitude intrinsic mode functions in a same time axis, and combining the initial instantaneous frequency component and all the plurality of first order instantaneous frequency components to obtain a frequency modulation spectrum, wherein in the frequency modulation spectrum, the plurality of first order frequency intrinsic mode functions are corresponding to the plurality of frequency intrinsic mode functions in a same time axis, furthermore, combining the amplitude modulation spectrum and the frequency modulation spectrum to obtain an amplitude-frequency modulation spectrum, wherein in the amplitude-frequency modulation spectrum, the plurality of first order amplitude intrinsic mode functions are corresponding to the plurality of first order frequency intrinsic mode functions in the same time axis.

18. The system according to claim 17, wherein the mode decomposition method is empirical mode decomposition method.

19. The system according to claim 17, wherein the amplitude modulation unit further includes:
repeating to choose one of the first order amplitude intrinsic mode functions, until obtaining a second order amplitude intrinsic mode component and a plurality of second order amplitude intrinsic mode functions from all of the first order amplitude intrinsic mode functions, furthermore, repeating to choose one of a plurality of (n−1)-th order amplitude intrinsic mode functions to obtain a n-th order amplitude intrinsic mode component and a plurality of n order amplitude intrinsic mode functions, until the plurality of n order amplitude intrinsic mode functions have no cyclic characteristics.

20. The system according to claim 17, wherein the frequency modulation unit further includes:
repeating to choose one of the first order frequency intrinsic mode functions, until obtaining a second order instantaneous frequency component and a plurality of second order frequency intrinsic mode functions from all of the first order frequency intrinsic mode functions, furthermore, repeating to choose one of a plurality of (n−1)-th order frequency intrinsic mode functions to obtain a n-th order instantaneous frequency component and a plurality of n-th order frequency intrinsic mode functions, until the plurality of n-th order frequency intrinsic mode functions have no cyclic characteristics.
